(19) United States
(12) Patent Application Publication
(10) Pub. No.: US 2020/0160492 A1
(43) Pub. Date: May 21, 2020

(54) Image Adjustment Method and Device, Image Display Method and Device, Non-Transitory Storage Medium

(71) Applicants: Hefei Xinsheng Optoelectronics Technology Co., Ltd., Anhui (CN); BOE Technology Group Co., Ltd., Beijing (CN)

(72) Inventors: Xiaoshi Liu, Beijing (CN); Hongjun Wang, Beijing (CN)

(73) Assignees: Hefei Xinsheng Optoelectronics Technology Co., Ltd., Anhui (CN); BOE Technology Group Co., Ltd., Beijing (CN)

(21) Appl. No.: 16/413,087

(22) Filed: May 15, 2019

(30) Foreign Application Priority Data
Nov. 16, 2018 (CN) 201811368016.2

(51) Int. Cl. G06T 5/00; G09G 5/02; G09G 5/10

(52) U.S. Cl. CPC G06T 5/009; G09G 2320/0233; G09G 5/10; G09G 5/026

(57) ABSTRACT

An image adjustment method and device, an image display method and device, and a non-transitory storage medium are disclosed. The image adjustment method includes: acquiring a saliency value of at least one pixel in an initial image; and performing a first brightness adjustment on a corresponding pixel in the at least one pixel in the initial image based on Weber's law.

### CROSS REFERENCE TO RELATED APPLICATIONS

The present application claims priority of Chinese Patent Application No. 201811368016.2 filed on Nov. 16, 2018, the disclosure of which is incorporated herein by reference in its entirety as part of the present application.

### TECHNICAL FIELD

Embodiments of the present disclosure relate to relate to an image adjustment method and device, an image display method and device, and a non-transitory storage medium.

### BACKGROUND

With the rapid development of display technology, display panels are developed toward display panels with large sizes. The display panels with large sizes are usually designed to have more pixels so as to ensure the resolution of the display panels, and each pixel is driven by corresponding pixel drive circuit to emit light, and therefore, the power consumption of the large-size display panel can be high.

### SUMMARY

At least one embodiment of the present disclosure provides an image adjustment method, which comprises: acquiring a saliency value of at least one pixel in an initial image; and performing a first brightness adjustment on a corresponding pixel in the at least one pixel in the initial image based on Weber's law.

For example, in at least one example of the image adjustment method, performing of the first brightness adjustment on the corresponding pixel in the initial image based on the Weber's law comprises: reducing brightness of the corresponding pixel in the at least one pixel based on the Weber's law, wherein the corresponding pixel is a first pixel of which a saliency value is not less than a saliency threshold.

For example, in at least one example of the image adjustment method, performing of the first brightness adjustment on the corresponding pixel in the initial image based on the Weber's law comprises: determining the corresponding pixel according to whether or not a saliency value of each pixel in the at least one pixel is less than a saliency threshold, wherein a saliency value of the corresponding pixel is not less than the saliency threshold; and performing the first brightness adjustment on the corresponding pixel based on the Weber's law.

For example, in at least one example of the image adjustment method, performing of the first brightness adjustment on the corresponding pixel based on the Weber's law comprises: allowing a brightness reduction value of the corresponding pixel to be not greater than a brightness difference threshold acquired based on the Weber's law, wherein the brightness reduction value of the corresponding pixel is equal to a difference between a brightness value of the corresponding pixel before the first brightness adjustment and a brightness value of the corresponding pixel after the first brightness adjustment.

For example, in at least one example of the image adjustment method, the brightness difference threshold ΔIth and the brightness value I1 of the corresponding pixel after the first brightness adjustment respectively satisfy following expressions: ΔIth=k×I; (1−k)×I≤I1<I; wherein k is a Weber constant, and I is the brightness value of the corresponding pixel before the first brightness adjustment.

For example, in at least one example of the image adjustment method, the method further comprises: determining a second pixel according to whether or not the saliency value of the each pixel in the at least one pixel is less than the saliency threshold, wherein a saliency value of the second pixel is less than the saliency threshold; determining a brightness adjustment degree of the second pixel based on the saliency value of the second pixel, wherein the brightness adjustment degree is negatively correlated to the saliency value of the second pixel; and performing a second brightness adjustment on the second pixel according to the brightness adjustment degree.

For example, in at least one example of the image adjustment method, the brightness adjustment degree and the saliency value of the second pixel have a linear relationship.

For example, in at least one example of the image adjustment method, a value range of the brightness adjustment degree is [kₘᵢₙ, kₘₐₓ]; a saliency value of a pixel with minimum saliency value in the initial image is Sₘᵢₙ; the saliency threshold is Sₘₑₐₙ; and the brightness adjustment degree k(x,y) of the second pixel at a position of (x,y) satisfies:

$$k ( x , y ) = \frac{{k}_{max} - {k}_{min}}{{S}_{min} - {S}_{mean}} ( S ( x , y ) - {S}_{mean} ) + {k}_{min} ,$$

wherein S(x,y) refers to the saliency value of the second pixel at the position of (x,y); kmax refers to a maximum value of the brightness adjustment degree that guarantees that quality of an image after the second brightness adjustment is not reduced; and kmin refers to a minimum value of the brightness adjustment degree.

For example, in at least one example of the image adjustment method, performing of the second brightness adjustment on the second pixel according to the brightness adjustment degree comprises: performing the second brightness adjustment on the second pixel at the position of (x,y) via a brightness adjustment formula, wherein the brightness adjustment formula satisfy: I′(x,y)=(1−k(x,y))×I(x,y); wherein I(x,y) refers to an initial brightness value of the second pixel at the position of (x,y), and I′(x,y) refers to a brightness value of the second pixel at the position of (x,y) after the second brightness adjustment.

For example, in at least one example of the image adjustment method, acquiring of the saliency value of the at least one pixel in the initial image comprises: converting the initial image into a YUV image; and acquiring a saliency value of each pixel in the YUV image.

For example, in at least one example of the image adjustment method, performing of the first brightness adjustment on the corresponding pixel in the initial image based on the Weber's law comprises: performing the first brightness adjustment on a corresponding pixel in the YUV image.

For example, in at least one example of the image adjustment method, the method further comprises: converting the YUV image into a target image after the first brightness adjustment, wherein the target image and the initial image adopt same one color coding method.

For example, in at least one example of the image adjustment method, after acquiring of the saliency value of the at least one pixel in the initial image, the method further comprises: calculating an average value of saliency values of all pixels in the YUV image, and taking the average value as a saliency threshold.

At least one embodiment of the present disclosure provides an image display method, which comprises: obtaining an image after the first brightness adjustment by executing the image adjustment method provided by any embodiment of the present disclosure on the initial image; and displaying the image after the first brightness adjustment.

At least one embodiment of the present disclosure provides an image adjustment device, which comprises: an acquisition unit configured to acquire a saliency value of at least one pixel in an initial image; and a brightness adjustment unit configured to perform a first brightness adjustment on a corresponding pixel in the initial image based on Weber's law.

At least one embodiment of the present disclosure provides an image display device, which comprises: a display element and the image adjustment device provided by any embodiment of the present disclosure, wherein the display element is configured to display an image after the first brightness adjustment.

At least one embodiment of the present disclosure provides an image adjustment device, which comprises: a processor and a memory, wherein computer program instructions that are suitable to be executed by the processor are stored in the memory; and upon being executed by the processor, the computer program instructions cause the processor to carry out a following method comprises: acquiring a saliency value of at least one pixel in an initial image; and performing a first brightness adjustment on a corresponding pixel in the initial image based on Weber's law.

For example, in at least one example of the image adjustment device, performing of the first brightness adjustment on the corresponding pixel in the initial image based on the Weber's law comprises: reducing brightness of the corresponding pixel in the at least one pixel based on the Weber's law, wherein the corresponding pixel is a first pixel of which a saliency value is not less than a saliency threshold.

At least one embodiment of the present disclosure provides a non-transitory storage medium, wherein computer program instructions are stored in the non-transitory storage medium; and the computer program instructions, upon being executed by a processor, cause a computer to carry out the image adjustment method provided by any embodiment of the present disclosure is executed.

### BRIEF DESCRIPTION OF THE DRAWINGS

In order to clearly illustrate the technical solution of the embodiments of the disclosure, the drawings of the embodiments will be briefly described in the following; it is obvious that the described drawings are only related to some embodiments of the disclosure and thus are not limitative of the disclosure.

FIG. 1 is a flowchart illustrating an image adjustment method and an image display method provided by at least one embodiment of the present disclosure;

FIG. 2 is a flowchart illustrating another image adjustment method and another image display method provided by at least one embodiment of the present disclosure;

FIG. 3 is a flowchart illustrating a method for performing brightness adjustment on pixels, provided by at least one embodiment of the present disclosure;

FIG. 4 is a block diagram illustrating an image adjustment device and an image display device provided by at least one embodiment of the present disclosure;

FIG. 5 is a block diagram illustrating another image adjustment device and another image display device provided by at least one embodiment of the present disclosure;

FIG. 6 is a block diagram illustrating still another image adjustment device provided by at least one embodiment of the present disclosure;

FIG. 7 is a block diagram illustrating still another image display device provided by at least one embodiment of the present disclosure; and

FIG. 8 is a block diagram illustrating a non-transitory storage medium provided by at least one embodiment of the present disclosure.

### DETAILED DESCRIPTION

In order to make objects, technical details and advantages of the embodiments of the disclosure apparent, the technical solutions of the embodiments will be described in a clearly and fully understandable way in connection with the drawings related to the embodiments of the disclosure. Apparently, the described embodiments are just a part but not all of the embodiments of the disclosure. Based on the described embodiments herein, those skilled in the art can obtain other embodiment(s), without any inventive work, which should be within the scope of the disclosure.

Unless otherwise defined, all the technical and scientific terms used herein have the same meanings as commonly understood by one of ordinary skill in the art to which the present disclosure belongs. The terms “first,” “second,” etc., which are used in the description and the claims of the present application for disclosure, are not intended to indicate any sequence, amount or importance, but distinguish various components. Also, the terms such as “a,” “an,” etc., are not intended to limit the amount, but indicate the existence of at least one. The terms “comprise,” “comprising,” “include,” “including,” etc., are intended to specify that the elements or the objects stated before these terms encompass the elements or the objects and equivalents thereof listed after these terms, but do not preclude the other elements or objects. The phrases “connect”, “connected”, etc., are not intended to define a physical connection or mechanical connection, but may include an electrical connection, directly or indirectly. “On,” “under,” “right,” “left” and the like are only used to indicate relative position relationship, and when the position of the object which is described is changed, the relative position relationship may be changed accordingly.

The inventors of the present disclosure have noted in the study that the power consumption of a display panel can be reduced by reducing the aperture ratio of the pixels of the display panel, where the aperture ratio of the pixels refers to the ratio of the light-emitting area (the light transmission area or the luminous area) to the pixel area. For example, when the luminous area of pixels of a self-luminous display panel is reduced, the power consumption of the display panel can be reduced. However, the reduction of the aperture ratio of the pixel can reduce the overall display brightness of the display panel and the display effect of the display panel.

In order to facilitate the reader's understanding of the present disclosure, some terms in the present disclosure are explained accordingly at first.

Image saliency: an important visual characteristic of an image that is used to describe the emphasis (the degree of attention) of a human eye on each area of the image. Image saliency can be described by a saliency map which contains the saliency values of image pixels in the image.

Saliency value of image pixel: used to describe the degree of stimulation of an image pixel of the image to the human eye. The greater the saliency value of the image pixel, the greater the degree of stimulation of the image pixel to the human eye, that is, the higher the degree of saliency of the image pixel. The smaller the saliency value of the image pixel, the smaller the stimulation of the image pixel to the human eye, that is, the lower the degree of saliency of the image pixel.

Weber's Law: the Weber's law describes the relationship between the psychological quantity and the physical quantity, that is, the threshold of the value of the change of the stimulation (the difference between the stimulation value before the stimulation is changed and the stimulation value after the stimulation is changed) that can be felt by the human body is changed along with the change of the original quantity of stimulation (the value of stimulation before the stimulation is changed), and has certain regularity. Supposing that I is the original quantity of stimulation, ΔI being the stimulation increment, ΔIth being the difference threshold, that is, the threshold at which the human body can feel that the stimulation is changed. For example, when ΔI is greater than or equal to ΔIth, the human body can feel the change of stimulation, and when ΔI is greater than zero and less than ΔIth, the human body does not feel the change of stimulation. When I is within a certain range (for example, when the stimulation is medium-intensity stimulation), the ratio of ΔIth to I is a constant, and here, the ratio of ΔIth to I (ΔIth/I) is referred to as Weber ratio. For example, the change of the stimulation that the human body can feel depends on the value of the stimulation before the stimulation is changed. When the change of the value of the stimulation is within the difference threshold, the feeling, which is caused by the stimulation, of the human body is not changed, that is the human body does not feel the change in stimulation.

For example, according to Weber's law, if there is a difference value that can be perceived by the human eye between the brightness of an object and the background brightness around the object, when the difference value is within a certain range, the ratio of the difference value to the brightness of the object remains the same. For example, when the background brightness value is within a certain range and the background brightness changes, the perceived brightness of the human eye on the object does not change.

At least one embodiment of the present disclosure provides an image adjustment method and device, an image display method and device, and a non-transitory storage medium. The image adjustment method comprises: acquiring the saliency value of at least one pixel in an initial image; and performing brightness adjustment on corresponding pixel in the initial image based on Weber's law. The image display method comprises: obtaining an image after brightness adjustment by executing the image adjustment method, provided by any embodiment of the present disclosure, on the initial image; and displaying the image after the brightness adjustment.

In some examples, by adoption of the Weber's law to adjust the brightness of the at least one pixel in the initial image, the brightness of the at least one pixel in the initial image can be reduced while guaranteeing the viewer of the image does not feel the change of the image brightness, thereby reducing the power consumption of a display panel and a display device for displaying the image after the brightness adjustment obtained by the image adjustment method.

Non-limitative descriptions are given to the image adjustment method and the image adjustment device provided by at least an embodiment of the present disclosure in the following with reference to a plurality of examples. As described in the following, in case of no conflict, different features in these specific examples may be combined so as to obtain new examples, and the new examples are also fall within the scope of present disclosure.

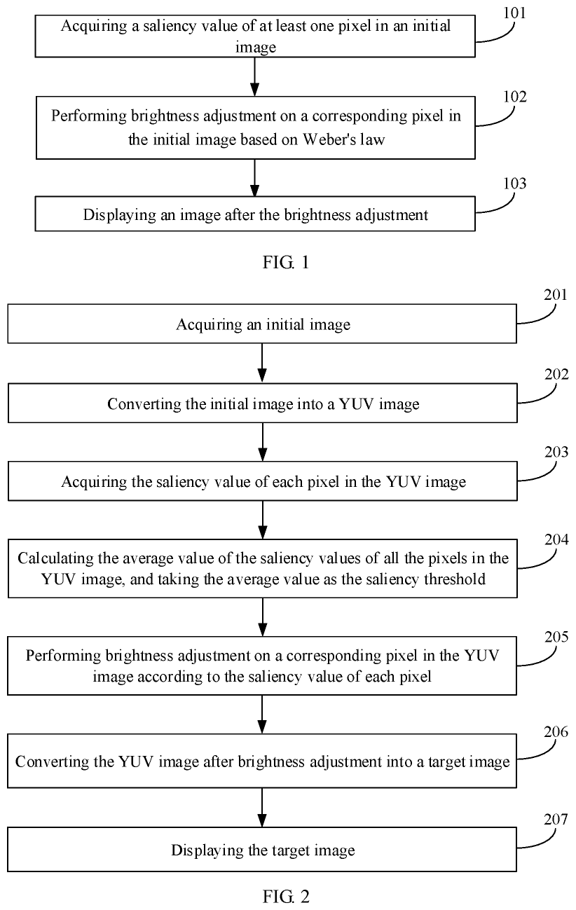

FIG. 1 is a flowchart illustrating an image adjustment method and an image display method provided by at least one embodiment of the present disclosure. As illustrated in FIG. 1, the image adjustment method comprises the steps S101 and S102 as illustrated in FIG. 1.

S101: acquiring a saliency value of at least one pixel in an initial image.

For example, the saliency value of each pixel (each image pixel) in the initial image may be acquired in the step S101. For example, the saliency value of each pixel may be calculated based on a maximum symmetric surround (MSS) algorithm. The specific method may refer to the example as illustrated in FIG. 2 and will not be further described here.

S102: performing brightness adjustment on a corresponding pixel in the initial image (in the at least one pixel in the initial image) based on Weber's law.

In at least one embodiment of the present disclosure, the adjustment of the brightness of the pixel in the initial image (in the at least one pixel in the initial image) based on Weber's law may be performed through reducing the brightness of the corresponding pixel in the initial image based on Weber's law.

For example, as for a pixel (that is, a first pixel) in the at least one pixel in the initial image (the saliency value of the first pixel is not less than the saliency threshold), the brightness of the pixel (that is, the first pixel) may be reduced based on Weber's law. For example, the brightness of all the first pixels in the at least one pixel (the saliency values of all the first pixels are not less than the saliency threshold) may be reduced based on Weber's law. The first pixels can be determined according to the saliency value of each pixel in the at least one pixel (for example, all the pixels of the initial image) in the initial image.

For example, when the saliency value of the pixel is not less than the saliency threshold, the brightness reduction value of the pixel may be not greater than the brightness difference threshold acquired based on Weber's law. For example, the brightness difference threshold ΔIth and the brightness value of the pixel after adjustment I1 respectively satisfy the following expressions: ΔIth=k×I; I1≥(1−k) I, in which k is a Weber constant, and I refers to as the brightness value of the pixel before adjustment.

For example, when the brightness reduction value of the pixel is not greater than the brightness difference threshold acquired based on Weber's law, a viewer of the image cannot feel the change of the image brightness, and therefore, the power consumption of the display panel and the display device for displaying the image after brightness adjustment can be reduced.

For example, as for a pixel (that is, a second pixel) in the at least one pixel (the saliency value of the second pixel is less than the saliency threshold), the brightness reduction value of the pixel (that is, the second pixel) may be greater than or equal to the brightness difference threshold acquired based on Weber's law, and therefore, the power consumption of the display panel and the display device for displaying the image after brightness adjustment can be further reduced. Because the viewer of the image pays less attention to the second pixels whose saliency values are less than the saliency threshold, the user may not feel the change of the image brightness even when the brightness reduction value of the second pixels is greater than or equal to the brightness difference threshold acquired based on Weber's law.

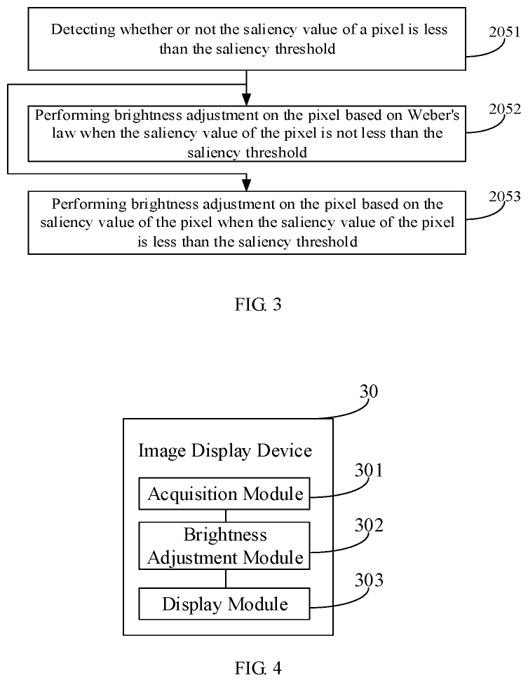

For example, when the saliency value of a pixel (that is, a second pixel) is less than the saliency threshold, the brightness adjustment degree of the pixel (that is, the second pixel) may be determined based on the saliency value of the pixel (that is, the second pixel), and the brightness adjustment degree of the second pixel may be negatively correlated to the saliency value of the second pixel; and the brightness of the pixel (that is, the second pixel) is adjusted according to the brightness adjustment degree. For example, the brightness adjustment degree and the saliency value have a linear relationship. For example, specific method of adjusting the pixels of which the saliency value is less than the saliency threshold may refer to the example as illustrated in FIG. 3, and therefore no further description will be given here.

For example, the brightness of each pixel in the initial image may be adjusted based on Weber's law, such that the method and the device for adjusting the brightness can be simplified.

The image display method comprises the following step S103.

S103: displaying an image after the brightness adjustment.

In the image display method provided by at least one embodiment of the present disclosure, the saliency value of the at least one pixel in the initial image is acquired; a corresponding pixel in the initial image is subjected to brightness adjustment; and the image after brightness adjustment is displayed by the display panel. In at least one embodiment, each of the at least one pixel is assigned as a salient pixel (that is, a first pixel) or a non-salient pixel (that is, a second pixel) according to the saliency value of each pixel in the at least one pixel, and different brightness adjustment methods are applied to the salient pixel (that is, the first pixel) and the non-salient pixel (that is, the second pixel). Because the reduction of the brightness of the corresponding pixel in the initial image based on Weber's law cannot cause change in the perceived brightness of the human eye to the pixel, compared with relevant techniques, the display effect of the display panel is guaranteed while reducing the power consumption of the display panel.

For example, FIG. 2 is a flowchart illustrating another image adjustment method and another image display method provided by at least one embodiment of the present disclosure. For example, the image adjustment method provided by at least one embodiment of the present disclosure can be used for reducing the brightness of at least one pixel in an initial image so as to acquire the image after the brightness adjustment (after the brightness reduction). The image display method provided by at least one embodiment of the present disclosure can be adopted to display the above image after the brightness adjustment, so that the power consumption of the display panel and the display device employing the above image display method can be reduced in the case where the viewer of the image does not feel the change in the image brightness.

As illustrated in FIG. 2, the image adjustment method comprises the following steps S201 to S206.

S201: acquiring an initial image.

The image display method provided by at least one embodiment of the present disclosure can be applied to a display device. The display device may be a device having display function such as an e-paper, a mobile phone, a tablet PC, a TV, a display, a notebook computer, a digital album or a navigator. Illustratively, when the display device (such as a mobile phone or a computer) is a device equipped with a camera component, the initial image not only can be acquired by the camera component of the display device but also can be obtained by receiving display image data from the outside of the display device. When the display device is a TV or a display, the initial image can be obtained from video data stream (or image data) transmitted to the display device.

For example, the initial image is a color image, and each pixel (image pixel) in the color image includes a plurality of subpixels of different colors (image subpixels). For example, each pixel may include a red subpixel (R), a green subpixel (G) and a blue subpixel (B). An image formed by pixels of R subpixels, pixels of G subpixels and pixels of B subpixels can be referred to as an RGB image (that is, an image using RGB values to describe color). In some other embodiments of the present disclosure, the initial image may also be a grayscale image. No limitation will be given here to the embodiment of the present disclosure.

For example, after the initial image is acquired, the initial image may be subjected to image preprocessing. For example, the initial image may be subjected to Gaussian filtering to remove Gaussian noises in the image.

S202: converting the initial image into a YUV image.

For example, the conversion of the initial image into the YUV image refers to the conversion of the format or the color coding method of the initial image into YUV format or YUV color coding method. For example, the YUV image refers to an image adopting the YUV color coding method.

The YUV image contains a Y component, a U component and a V component. The Y component represents brightness (that is, grayscale value). For example, the U component represents chrominance; the V component represents chroma; and the combination of the U component and the V component are represent color. For another example, the U component represents saturation; the V component represents tone; and the combination of the U component and the V component reflects chrominance.

It should be noted that the conversion of the initial image into the YUV image facilitates the acquisition of the brightness of the pixels in the image so as to realize the brightness adjustment on the pixels.

For example, the embodiments of the present disclosure is not limited to convert the initial image into the YUV image, and the initial image may also be converted into an image adopting other suitable color coding methods according to actual application demands, as long as the brightness and the chrominance in the initial image are separated. For example, when the initial image is a grayscale image, the step S202 may be not performed. In this case, the steps of calculating the saliency value and the average value of the saliency values and adjusting the brightness are all performed with respect to the initial image (an initial image of which the color coding method has not been changed).

Illustratively, when the initial image is an RGB image, the RGB image can be converted into the YUV image according to the following formula (1).

$$[ \begin{matrix}Y \\ U \\ V\end{matrix} ] = [ \begin{matrix}+ 0.299 & + 0.587 & + 0.114 \\ - 0.147 & - 0.289 & + 0.436 \\ + 0.615 & - 0.515 & - 0.100\end{matrix} ] \times [ \begin{matrix}R \\ G \\ B\end{matrix} ] \qquad Equation ( 1 )$$

S203: acquiring the saliency value of each pixel in the YUV image.

For example, the saliency value of each pixel in the YUV image may be calculated by the MSS algorithm. One example of specific calculation method is as follows.

As for any pixel (x, y) that is, a pixel disposed at position (x, y) in the YUV image, the saliency value of the pixel (x, y) may be calculated according to the following formula (2).

S(x,y)=∥I_{U}(x,y)−I_{f}(x,y)∥ Equation (2).

Here, I_{U}(x, y) is the average value of the brightness of all the pixels in the MSS area; I_{f}(x, y) represents the brightness of the pixel (x, y); and S(x, y) represents the saliency value of the pixel (x, y). For example, when the image adjustment method comprises the step of image preprocessing (for example, Gaussian filtering), both I_{U}(x, y) and I_{f}(x, y) are acquired based on an initial image obtained after image preprocessing. For example, I_{f}(x, y) represents the brightness of the pixel (x, y) after Gaussian filtering.

The formula (2) indicates that the saliency value S(x, y) of the pixel (x, y) is equal to the square root of the quadratic sum of the difference between I_{U}(x, y) and I_{f}(x, y).

It should be noted that the MSS area of the pixel (x, y) refers to the largest area on the image that can be divided by taking the pixel (x, y) as center. The MSS area is centrally symmetric by taking the pixel (x, y) as the center.

Illustratively, when the MSS area of the pixel (x, y) is a rectangular area, the height of the YUV image is h and the width is w, so I_{U}(x, y) may be calculated according to the following formula (3).

$${I}_{U} ( x , y ) = \frac{1}{A} {\sum }_{i = x - {x}_{0}}^{x + {x}_{0}} {\sum }_{j = y - {y}_{0}}^{y + {y}_{0}} I ( {x}_{i} , {y}_{j} ) \qquad Equation ( 3 )$$

Here, x₀ and y₀ are parameters for controlling the size of the MSS area; A refers to the area of the MSS area of the pixel (x, y); x₀, y₀ and A are respectively satisfy the following expressions:

x₀=min(x,w−x)

y₀=min(y,h−y)

A=(2x₀+1)(2y₀+1)

For example, the specific method for setting x₀ and y₀ may refer to relevant technique, and therefore, no further description will be given here.

S204: calculating the average value of the saliency values of all the pixels in the YUV image, and taking the average value as the saliency threshold.

For example, the saliency value may be the average value of the saliency values of all the pixels in the YUV image; for another example, the saliency value may also be a medium value of the saliency values of all the pixels in the YUV image. No limitation will be given to the specific method for setting the saliency threshold in the embodiment of the present disclosure.

For example, the pixels in the image can be divided into salient pixels (that is, first pixels) and non-salient pixels (that is, second pixels) according to the saliency values of the pixels in the image and the saliency threshold. Here, pixels of which the saliency value is not less than the saliency threshold are salient pixels, and pixels of which the saliency value is less than the saliency threshold are non-salient pixels. The sensitivity of the human eye to the brightness change of the salient pixels is higher than the sensitivity of the human eye to the brightness change of the non-salient pixels.

S205: performing brightness adjustment on a corresponding pixel in the YUV image according to the saliency value of each pixel.

Because the sensitivity of the human eye to the brightness change of the salient pixels is different from the sensitivity of the human eye to the brightness change of the non-salient pixels, in at least one embodiment of the present disclosure, different brightness adjustment methods may be adopted for the salient pixels and the non-salient pixels, so as to reduce the power consumption as much as possible. However, the embodiments of the present disclosure are not limited thereto. For example, all the salient pixels and the non-salient pixels may be subjected to brightness adjustment based on Weber's law, that is, the change of the brightness of all the pixels is allowed to be less than or equal to (for example, equal to) the brightness difference threshold obtained based on Weber's law, and therefore, the image adjustment method can be simplified.

FIG. 3 is a flowchart illustrating a method for adjusting the brightness of the pixels in at least one embodiment of the present disclosure. The brightness adjustment method may be applied to any pixel in the YUV image. As illustrated in FIG. 3, the method comprises the following steps S2051 to S2053.

S2051: detecting (for example, determining) whether or not the saliency value of a pixel is less than the saliency threshold according to the saliency value of the at least one pixel.

For example, a saliency map can be obtained after acquiring the saliency value of each pixel in the YUV image. For example, the saliency map may be a two-dimensional map. In this case, the horizontal coordinate of the saliency map may represent each pixel; the vertical coordinate of the saliency map may represent the saliency value of corresponding pixels; the saliency threshold may be represented by a straight line parallel to the horizontal axis on the saliency map; and the relationship between the saliency value of the pixel and the saliency threshold can be compared through the saliency map directly and intuitively. For another example, the saliency map may also be a three-dimensional map. In this case, the X coordinate and the Y coordinate of the saliency map may represent the position (x, y) of the pixel, and the Z coordinate of the saliency map may represent the saliency value of the pixel at the position (x, y).

S2052: performing brightness adjustment on the pixel based on Weber's law when the saliency value of the pixel is not less than the saliency threshold.

It should be noted that the brightness change of the salient pixels has a greater impact on the subjective brightness of the human eye (for example, the brightness perceived and felt by the human eye), the salient pixels may be subjected to brightness adjustment based on Weber's law. For example, the brightness adjustment value of the salient pixel and the initial brightness value of the salient pixel are in accordance with the Weber ratio (for example, the ratio of the brightness adjustment value of the salient pixel to the initial brightness value of the salient pixel is less than or equal to the Weber ratio or the Weber coefficient), so as to ensure that the brightness adjustment of the salient pixels do not affect the perceived brightness of the human eye, and guarantee the display effect of the display panel.

For example, the pixel (the salient pixel or the first pixel) that is at the location (x,y) may be subjected to brightness adjustment by a brightness adjustment formula. The brightness adjustment formula is: I′(x,y)=(1−k(x,y))×I(x,y).

Herein, I(x,y) represents the initial brightness value of the pixel (x,y); I′(x,y) represents the brightness of the pixel (x,y) after the brightness adjustment; k(x,y) represents the brightness adjustment degree of the pixel (x,y), and in the process of performing brightness adjustment on the pixel based on Weber's law, the brightness adjustment degree is the Weber ratio for indicating the threshold that the human eye perceives the brightness change and may take the value of 0.02.

It should be noted that according to actual application demands, the brightness value after the brightness adjustment may also be larger than (1−k(x,y))×I(x,y) and smaller than I(x,y). In this case, the brightness adjustment degree is the ratio of the brightness adjustment value of the salient pixel to the initial brightness value of the salient pixel, and the brightness adjustment degree is less than or equal to the Weber ratio or the Weber coefficient. For example, when the brightness value after brightness adjustment is larger than (−k(x,y))×I(x,y) and smaller than I(x,y), although the power consumption reduction is less than the power consumption reduction of the example where the brightness value after brightness adjustment satisfies I′(x,y)=(1−k(x,y))×I(x,y), the power consumption can be still less than the power consumption in relevant techniques.

S2053: performing brightness adjustment on the pixel based on the saliency value of the pixel when the saliency value of the pixel is less than the saliency threshold.

It should be noted that the brightness change of the non-salient pixel has a smaller impact on the subjective brightness of the human eye, the non-salient pixel may be not subjected to brightness adjustment based on Weber's law. Because the smaller the saliency value of the pixel, the smaller the impact of the brightness change of the pixel on the subjective brightness of the human eye, the brightness adjustment degree of different pixels (non-salient pixels) may be determined according to the saliency value of the pixel. The smaller the saliency value of the pixel, the larger the acceptable brightness adjustment amplitude for this pixel and the larger the brightness adjustment degree of the pixel can be set.

For example, as for the non-salient pixel, the brightness adjustment degree of the pixel may be determined according to the saliency value of the pixel, and the brightness adjustment degree is negatively correlated to the saliency value; and the pixel is subjected to brightness adjustment according to the brightness adjustment degree.

It should be noted that in order to ensure the display effect of the display panel, the brightness adjustment degree of the non-salient pixel may be within a certain value range. The value range of the brightness adjustment degree of the non-salient pixel may be [kₘᵢₙ, kₘₐₓ], indicating that the maximum brightness adjustment degree of the non-salient pixel is kₘₐₓ and the minimum brightness adjustment degree of the non-salient pixel is kₘᵢₙ. For example, the minimum brightness adjustment degree of the non-salient pixel may be the Weber ratio indicating the threshold that the human eye perceives the brightness change, and the Weber ratio may take the value of 0.02; the maximum brightness adjustment degree may be determined according to actual demands; 0.02≤kₘₐₓ≤1; and kmax may be the maximum brightness adjustment degree that can guarantee that the quality of the image after brightness adjustment is not reduced.

For example, when the saliency value of the pixel with minimum saliency value in the initial image is Sₘᵢₙ and the saliency threshold is Sₘₑₐₙ, as for any pixel (x,y) of which the saliency value is less than the saliency threshold, that is, any non-salient pixel (x,y), the brightness adjustment degree k(x,y) of any pixel (any non-salient pixel or second pixel) satisfies:

$$k ( x , y ) = \frac{{k}_{max} - {k}_{min}}{{S}_{min} - {S}_{mean}} ( S ( x , y ) - {S}_{mean} ) + {k}_{min} .$$

Here, S(x,y) refers to the saliency value of any non-salient pixel (x,y).

For example, any non-salient pixel (x,y) may be subjected to brightness adjustment by adoption of a brightness adjustment formula. The brightness adjustment formula is: I′(x,y)=(1−k(x,y))×I(x,y); herein, I(x,y) represents the initial brightness value of any non-salient pixel (x,y); I′(x,y) represents the brightness value of any non-salient pixel (x,y) after brightness adjustment; and k(x,y) represents the brightness adjustment degree of any non-salient pixel. For example, according to actual application demands, as for any non-salient pixel of which the saliency value is less than the saliency threshold, the brightness adjustment degree of the non-salient pixel may also be larger than the Weber ratio (0.02) and smaller than k(x,y).

It should be noted that the brightness adjustment of the non-salient pixel by the above brightness adjustment method can further reduce the power consumption of the display panel while ensuring the display effect of the display panel.

For example, the non-salient pixel may also be subjected to brightness adjustment based on Weber's law, and the adjustment process may refer to the adjustment process of the salient pixel. No further description will be given here in the embodiment of the present disclosure.

S206: converting the YUV image after brightness adjustment into a target image.

For example, the target image and the initial image adopt the same color coding method. For example, when the initial image is an RGB image, the YUV image can be converted into an RGB image based on an inverse matrix of a variation matrix (for example, a matrix with three rows and three columns) in the formula (1).

It should be noted that the executing sequence of the steps of the image adjustment method provided by at least one embodiment of the present disclosure may be appropriately adjusted, and more or less steps may also be correspondingly adopted according to the specific implementation. For example, the steps S202 and S206 may be not executed. Any variation in the method that can be easily envisaged by those skilled in the art based on the technical content disclosed in the present disclosure shall fall within the scope of protection of the present disclosure, and therefore, no further description will be given regarding the above mentioned variation here.

The image display method comprises the following step S207.

S207: displaying the target image.

For example, the target image may be displayed by a display element (for example, a display panel).

For example, the brightness adjustment for the salient pixel and the brightness adjustment for the non-salient pixel may be performed at the same time.

In the image display method provided by at least one embodiment of the present disclosure, the saliency value of at least one pixel in the initial image is acquired; a corresponding pixel in the initial image is subjected to brightness adjustment; and the image after brightness adjustment is displayed by the display panel. In at least one embodiment, each of the at least one pixel is assigned as a salient pixel (that is, a first pixel) or a non-salient pixel (that is, a second pixel) according to the saliency value of each pixel in the at least one pixel, and different brightness adjustment methods are applied to the salient pixel (that is, the first pixel) and the non-salient pixel (that is, the second pixel). For example, as for the salient pixel, because the reduction of the brightness of the corresponding pixel in the initial image based on Weber's law cannot cause the change in the perceived brightness of the human eye to the pixel, compared with relevant technique, the display effect of the display panel is guaranteed while reducing the power consumption of the display panel. In addition, as for the non-salient pixel, the brightness of the pixel is subjected to adjustment with a suitable brightness adjustment degree based on the saliency values of the pixel. The smaller the saliency value of the pixel, the higher the brightness adjustment degree of the pixel, such that the reduction of the power consumption of the display panel can be maximized while guaranteeing the display effect of the display panel.

FIG. 4 is a schematic structural view illustrating an image adjustment device and an image display device provided by at least one embodiment of the present disclosure. As illustrated in FIG. 4, the image adjustment device comprises an acquisition module (for example, an acquisition device) 301 and a brightness adjustment module (a brightness adjustment device) 302. The image display device 30 comprises the image adjustment device and a display module (a display element) 303.

The acquisition module 301 is configured to acquire the saliency value of at least one pixel in the initial image. The brightness adjustment module 302 is configured to perform brightness adjustment on a corresponding pixel in the initial image based on Weber's law. For example, the acquisition module (for example, the acquisition unit) 301 and the brightness adjustment module (the brightness adjustment unit) 302 may be respectively implemented by software, firmware, hardware or any combination thereof. For example, the hardware includes field programmable gate array (FPGA), etc. For example, the acquisition module (for example, the acquisition unit) 301 and the brightness adjustment module (the brightness adjustment unit) 302 may include a processor and a memory. For example, the specific implementation of the processor and the memory may refer to the embodiment as illustrated in FIG. 6, and therefore, no further description will be given here.

The display module 303 is configured to display the image after the brightness adjustment. For example, the display module (the display element) 303 may be implemented as a display panel. The display panel, for example, may be a self-luminous display panel.

In the image display device provided by at least one embodiment of the present disclosure, the saliency value of at least one pixel in the initial image is acquired by the acquisition module; a corresponding pixel in the initial image is subjected to brightness adjustment performed by the brightness adjustment module; and the image after brightness adjustment is displayed by the display panel of the display module. In at least one embodiment, each of the at least one pixel is assigned as a salient pixel (that is, a first pixel) or a non-salient pixel (that is, a second pixel) according to the saliency value of each pixel in the at least one pixel, and different brightness adjustment methods are applied to the salient pixel (that is, the first pixel) and the non-salient pixel (that is, the second pixel). For example, because the reduction of the brightness of the pixel in the initial image based on Weber's law cannot cause the change in the perceived brightness of the human eye to the pixel, compared with relevant technique, the display effect of the display panel is guaranteed while reducing the power consumption of the display panel.

For example, the brightness adjustment module is further configured to: detect whether or not the saliency value of the pixel is less than the saliency threshold as for each pixel in at least one pixel; and perform brightness adjustment on the pixel based on Weber's law as for the pixel of which the saliency value of the pixel is not less than the saliency threshold.

For example, the brightness adjustment module is further configured to: determine the brightness adjustment degree of the pixel based on the saliency value of the pixel as for the pixel of which the saliency value is less than the saliency threshold, in which the brightness adjustment degree is negatively correlated to the saliency value; and perform brightness adjustment on the pixel according to the brightness adjustment degree as for the pixel of which the saliency value is less than the saliency threshold.

For example, the value range of the brightness adjustment degree is [kₘᵢₙ, kₘₐₓ]; the saliency value of the pixel with minimum saliency value in the initial image is Sₘᵢₙ; the saliency threshold is Sₘₑₐₙ; and as for any non-salient pixel (x,y) of which the saliency value is less than the saliency threshold, the brightness adjustment degree k(x,y) of any non-salient pixel satisfies:

$$k ( x , y ) = \frac{{k}_{max} - {k}_{min}}{{S}_{min} - {S}_{mean}} ( S ( x , y ) - {S}_{mean} ) + {k}_{min} ;$$

here, S(x,y) represents the saliency value of any non-salient pixel (x,y).

The brightness adjustment module is further configured to: perform brightness adjustment on any non-salient pixel by adoption of a brightness adjustment formula. The brightness adjustment formula is: I′(x,y)=(1−k(x,y))×I(x,y); here, I(x,y) represents the initial brightness value of any non-salient pixel (x,y), and I′(x,y) represents the brightness value of any non-salient pixel (x,y) after brightness adjustment.

For example, the acquisition module is configured to: convert the initial image into a YUV image; and acquire the saliency value of each pixel in the YUV image.

For example, the brightness adjustment module is further configured to: perform brightness adjustment on a corresponding pixel in the YUV image.

For example, the display module is configured to: convert the YUV image after the brightness adjustment into a target image; and display the target image. In some examples, the conversion of the YUV image into the target image after the brightness adjustment may also be implemented by an image adjustment device that is separated from the display module.

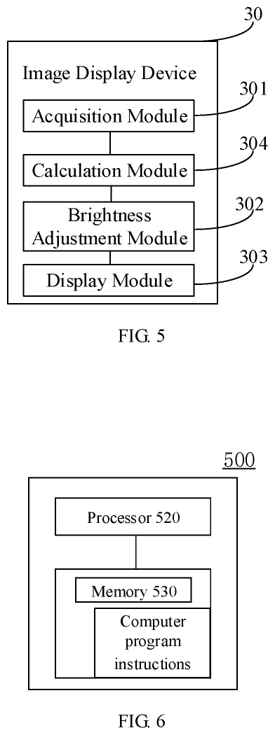

For example, as illustrated in FIG. 5, the display device 30 further comprises a calculation module (a calculating unit) 304. The calculation module 304 is configured to calculate the average value of the saliency values of all the pixels in the YUV image, and to take the average value as the saliency threshold. For example, the calculation module (calculator) 304 may be implemented by software, firmware, hardware or any combination thereof. For example, the calculation module (calculator) 304 may include a processor and a memory.

In the image display device provided by at least one embodiment of the present disclosure, the saliency value of at least one pixel in the initial image is acquired by the acquisition module; the corresponding pixel in the initial image is subjected to the brightness adjustment performed by the brightness adjustment module; and the image after the brightness adjustment is displayed by the display panel of the display module. In at least one embodiment, each of the at least one pixel is assigned as a salient pixel (that is, a first pixel) or a non-salient pixel (that is, a second pixel) according to the saliency value of each pixel in the at least one pixel, and different brightness adjustment methods are applied to the salient pixel (that is, the first pixel) and the non-salient pixel (that is, the second pixel). For example, as for the salient pixel, because the reduction of the brightness of the pixel in the initial image based on Weber's law cannot cause the change in the perceived brightness of the human eye to the pixel, compared with the relevant technique, the display effect of the display panel is guaranteed while reducing the power consumption of the display panel. In addition, as for non-salient pixels, the brightness of the pixel is subjected to adjustment with a suitable brightness adjustment degree based on the saliency values of the pixel. The smaller the saliency value of the pixel, the higher the brightness adjustment degree of the pixel, such that the reduction of the power consumption of the display panel can be maximized while guaranteeing the display effect of the display panel.

With regard to the device in the above embodiments, because the specific manner in which the modules perform the operations has been described in detail in the embodiments of the method, and will not be explained in detail here.

The embodiment of the present disclosure provides another image adjustment device 500. As illustrated in FIG. 6, the image adjustment device 500 (for example, integrated on an IC of the display device) may comprise: a processor 520 and a memory 530. Computer program instructions that are suitable to be executed by the processor are stored in the memory. When the computer program instructions are executed by the processor, the computer program instructions cause a computer to carry out the following method: acquiring the saliency value of at least one pixel in an initial image; and performing brightness adjustment on a corresponding pixel in the initial image based on Weber's law.

The processor, for example, is a central processing unit (CPU) or a processing unit in other forms having data processing capability and/or instruction execution capability. For example, the processor may be implemented as a general-purpose processor (GPP) and may also be a microcontroller, a microprocessor, a digital signal processor (DSP), a special-purpose image processing chip, a field programmable logic array (FPLA), and the like. The memory, for example, may include a volatile memory and/or a non-volatile memory, for example, may include a read-only memory (ROM), a hard disk, a flash memory, and the like. Correspondingly, the memory may be implemented as one or more computer program products. The computer program products may include computer readable storage media in various forms. One or more computer program instructions may be stored in the computer readable storage medium. The processor may run the program instructions to realize the function of the control device in the embodiment of the present disclosure as described below and/or other desired functions. The memory may also store various other application programs and various data, for example, the saliency value of at least one pixel in the initial image, and various data applied to and/or generated by the application programs.

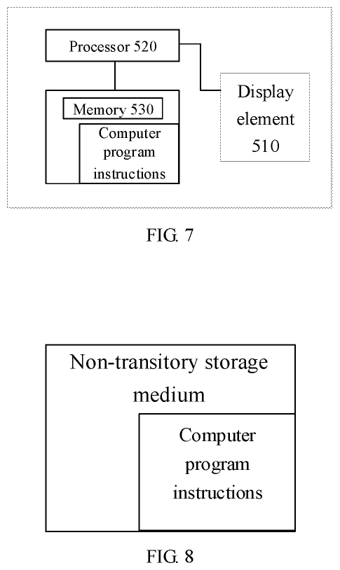

The embodiment of the present disclosure provides another image display device. As illustrated in FIG. 7, the image display device comprises the image adjustment device as illustrated in FIG. 6 and a display element 510.

For example, the display element 510 may be implemented as a display panel. The display panel, for example, may be a self-luminous display panel. The self-luminous display panel may be an organic light-emitting diode (OLED) display panel or a quantum dot light-emitting diode (QLED) display panel. Correspondingly, the above image display device may be an OLED display device or a QLED display device. In addition, the image display device may also be implemented as a liquid crystal display (LCD) device. No limitation will be given to the specific implementation mode of the above image display device in the embodiment of the present disclosure.

At least one embodiment of the present disclosure provides a non-transitory storage medium. As illustrated in FIG. 8, computer program instructions are stored in the non-transitory storage medium. When the computer program instructions are executed by the processor, the computer program instructions cause a computer to carry out the image adjustment method provided by any embodiment of the present disclosure. For example, the embodiment of the present disclosure provides still another image display device. The image display device comprises the computer storage medium as illustrated in FIG. 8 and the display element provided by any embodiment of the present disclosure.

The storage medium may include various kinds of computer readable storage media, e.g., volatile memories and/or nonvolatile memories. The volatile memory, for example, may include a random access memory (RAM) and/or a cache. The nonvolatile memory, for example, may include a magnetic storage medium, an optical storage medium or a semiconductor storage medium, e.g., a read-only memory (ROM), a hard disk or a flash memory.

It should be understood by those skilled in the art that all or part of the steps of implementing the above embodiments may be completed by hardware, or may be realized by adoption of a program which is configured to instruct related hardware, and the program may be stored in a computer readable storage medium. The above-mentioned storage medium may be an ROM, a magnetic disk, an optical disk, etc.

Although detailed description has been given above to the present disclosure with general description and embodiments, it shall be apparent to those skilled in the art that some modifications or improvements may be made on the basis of the embodiments of the present disclosure. Therefore, all the modifications or improvements made without departing from the spirit of the present disclosure shall all fall within the scope of protection of the present disclosure.

What are described above is related to the illustrative embodiments of the disclosure only and not limitative to the scope of the disclosure; the scopes of the disclosure are defined by the accompanying claims.

What is claimed is:

1. An image adjustment method, comprising:
acquiring a saliency value of at least one pixel in an initial image; and
performing a first brightness adjustment on a corresponding pixel in the at least one pixel in the initial image based on Weber's law.

2. The method according to claim 1, wherein performing of the first brightness adjustment on the corresponding pixel in the initial image based on the Weber's law comprises:
reducing brightness of the corresponding pixel in the at least one pixel based on the Weber's law, wherein the corresponding pixel is a first pixel of which a saliency value is not less than a saliency threshold.

3. The method according to claim 1, wherein performing of the first brightness adjustment on the corresponding pixel in the initial image based on the Weber's law comprises:
determining the corresponding pixel according to whether or not a saliency value of each pixel in the at least one pixel is less than a saliency threshold, wherein a saliency value of the corresponding pixel is not less than the saliency threshold; and
performing the first brightness adjustment on the corresponding pixel based on the Weber's law.

4. The method according to claim 3, wherein performing of the first brightness adjustment on the corresponding pixel based on the Weber's law comprises:
allowing a brightness reduction value of the corresponding pixel to be not greater than a brightness difference threshold acquired based on the Weber's law,
wherein the brightness reduction value of the corresponding pixel is equal to a difference between a brightness value of the corresponding pixel before the first brightness adjustment and a brightness value of the corresponding pixel after the first brightness adjustment.

5. The method according to claim 4, wherein the brightness difference threshold ΔIth and the brightness value I1 of the corresponding pixel after the first brightness adjustment respectively satisfy following expressions:
ΔIth=k×I;
(1−k)×I≤I1<I;
wherein k is a Weber constant, and I is the brightness value of the corresponding pixel before the first brightness adjustment.

6. The method according to claim 3, further comprising:
determining a second pixel according to whether or not the saliency value of the each pixel in the at least one pixel is less than the saliency threshold, wherein a saliency value of the second pixel is less than the saliency threshold;
determining a brightness adjustment degree of the second pixel based on the saliency value of the second pixel, wherein the brightness adjustment degree is negatively correlated to the saliency value of the second pixel; and
performing a second brightness adjustment on the second pixel according to the brightness adjustment degree.

7. The method according to claim 6, wherein the brightness adjustment degree and the saliency value of the second pixel have a linear relationship.

8. The method according to claim 7, wherein a value range of the brightness adjustment degree is [kₘᵢₙ, kₘₐₓ];
a saliency value of a pixel with minimum saliency value in the initial image is Sₘᵢₙ;
the saliency threshold is ₘₑₐₙ; and
the brightness adjustment degree k(x,y) of the second pixel at a position of (x,y) satisfies:
$$k ( x , y ) = \frac{{k}_{max} - {k}_{min}}{{S}_{min} - {S}_{mean}} ( S ( x , y ) - {S}_{mean} ) + {k}_{min} ,$$
wherein S(x,y) refers to the saliency value of the second pixel at the position of (x,y); kmax refers to a maximum value of the brightness adjustment degree that guarantees that quality of an image after the second brightness adjustment is not reduced; and kmin refers to a minimum value of the brightness adjustment degree.

9. The method according to claim 8, wherein performing of the second brightness adjustment on the second pixel according to the brightness adjustment degree comprises:
performing the second brightness adjustment on the second pixel at the position of (x,y) via a brightness adjustment formula,
wherein the brightness adjustment formula satisfy:
I′(x,y)=(1−k(x,y))×I(x,y);
wherein I(x,y) refers to an initial brightness value of the second pixel at the position of (x,y), and I′(x,y) refers to a brightness value of the second pixel at the position of (x,y) after the second brightness adjustment.

10. The method according to claim 1, wherein acquiring of the saliency value of the at least one pixel in the initial image comprises:
converting the initial image into a YUV image; and
acquiring a saliency value of each pixel in the YUV image.

11. The method according to claim 10, wherein performing of the first brightness adjustment on the corresponding pixel in the initial image based on the Weber's law comprises:
performing the first brightness adjustment on a corresponding pixel in the YUV image.

12. The method according to claim 10, further comprising: converting the YUV image into a target image after the first brightness adjustment, wherein the target image and the initial image adopt same one color coding method.

13. The method according to claim 10, wherein after acquiring of the saliency value of the at least one pixel in the initial image, the method further comprises:
calculating an average value of saliency values of all pixels in the YUV image, and taking the average value as a saliency threshold.

14. An image display method, comprising:
obtaining an image after the first brightness adjustment by executing the image adjustment method according to claim 1 on the initial image; and
displaying the image after the first brightness adjustment.

15. An image adjustment device, comprising:
an acquisition unit configured to acquire a saliency value of at least one pixel in an initial image; and
a brightness adjustment unit configured to perform a first brightness adjustment on a corresponding pixel in the initial image based on Weber's law.

16. An image display device, comprising: a display element and the image adjustment device according to claim 15, wherein the display element is configured to display an image after the first brightness adjustment.

17. An image adjustment device, comprising: a processor and a memory, wherein computer program instructions that are suitable to be executed by the processor are stored in the memory; and upon being executed by the processor, the computer program instructions cause the processor to carry out a following method comprising:
acquiring a saliency value of at least one pixel in an initial image; and
performing a first brightness adjustment on a corresponding pixel in the initial image based on Weber's law.

18. The image adjustment device according to claim 17, wherein performing of the first brightness adjustment on the corresponding pixel in the initial image based on the Weber's law comprises:
reducing brightness of the corresponding pixel in the at least one pixel based on the Weber's law, wherein the corresponding pixel is a first pixel of which a saliency value is not less than a saliency threshold.

19. An image display device, comprising: a display element and the image adjustment device according to claim 17,
wherein the display element is configured to display an image after the first brightness adjustment.

20. A non-transitory storage medium, wherein computer program instructions are stored in the non-transitory storage medium; and the computer program instructions, upon being executed by a processor, cause a computer to carry out the image adjustment method according to claim 1.
